(19) United States
(12) Patent Application Publication
(10) Pub. No.: US 2022/0050041 A1
(43) Pub. Date: Feb. 17, 2022

(54) METHOD FOR PROCESSING THE SIGNAL OF A PARTICLE SENSOR THAT OPERATES IN ACCORDANCE WITH THE PRINCIPLE OF LASER-INDUCED INCANDESCENCE, ASSEMBLY FOR PROCESSING SUCH A SIGNAL, AND PARTICLE SENSOR

(71) Applicant: Robert Bosch GmbH, Stuttgart (DE)

(72) Inventors: Markus Schreiber, Markgroeningen (DE); Michael Scholl, Backnang (DE); Michael Curcic, Stuttgart (DE); Radoslav Rusanov, Stuttgart (DE)

(21) Appl. No.: 17/299,175

(22) PCT Filed: Oct. 23, 2019
(86) PCT No.: PCT/EP2019/078891

§ 371 Date: Jun. 2, 2021

(30) Foreign Application Priority Data
Dec. 13, 2018 (DE) 10 2018 221 701.7

(51) Int. Cl. G01N 15/06

(52) U.S. Cl. CPC G01N 15/06; G01N 2015/0693

(57) ABSTRACT

A system for the processing of the output signal of a particle sensor that operates according to the principle of laser-induced incandescence. The system includes a detector that provides an output signal that characterizes an acquired temperature radiation. It is provided that: a.) the detector is designed and configured such that it provides an output signal that includes a plurality of pulses, and b.) the system includes a summer to which the output signal is supplied at least at times, and that is designed and configured such that it sums the output signal over a time interval.

### FIELD

The present invention relates to a method for processing the signal of a particle sensor that operates according to the principle of laser-induced incandescence, to a system for processing such a signal, and to a particle sensor.

### BACKGROUND INFORMATION

The principle of laser-induced incandescence (LII) has been used for the detection of nanoparticles in a gas, for example in air, and is for example also intensively applied to characterize the combustion process in “glass” motors in the laboratory, or to characterize exhaust gas in laboratory settings. Here, the particles, for example soot particles, are heated by a laser to several thousand degrees Celsius, so that they emit significant heat or temperature radiation. This thermally induced light emission of the particles is measured by a light detector. An optical soot particle sensor for motor vehicles that operates according to the principle of laser-induced incandescence is described in German Patent Application No. DE 10 2017 207 402 A1.

### SUMMARY

The underlying problem of the present invention is solved by a method in accordance with an example embodiment of the present invention, and by a system and a particle sensor in accordance with example embodiment of the present invention. Advantageous developments of the present invention are described herein.

The method according to the present invention is used for the detection of particles or aerosol in a fluid, for example an exhaust gas. It operates using the principle of laser-induced incandescence (LII). In accordance with an example embodiment of the present invention, at first using laser light that is emitted by a laser and is preferably focused in a spot, i.e., a volume region having very small dimensions in the μm range, with adequately high intensity, a particle is heated to several thousand degrees through partial absorption of the laser light. According to Planck's law of radiation, this hot particle gives off a characteristic temperature radiation (incandescence, or glow emission) that is used as a measurement signal and is received by a detector.

For this purpose, for example an optical element situated in the beam path of the laser is used that is designed and configured to focus the laser light emitted by the laser in the very small spot. Given a focus diameter of, e.g., 10 μm, it can be assumed that at a given time it is always the case that only one particle is passing through the spot (intrinsic single-particle detectability), if a particle concentration of 10¹³/m³ is assumed. The detector is configured and situated so that it detects the temperature radiation emitting from the spot. As lasers, low-cost semiconductor laser diodes may be used. The detection of the temperature radiation can take place for example using a multi-pixel photon counter (MPPC) or a silicon photon multiplier (SiPM).

In accordance with an example embodiment of the present invention, the method according to the present invention includes the following steps:
a. provision of an output signal by the detector, the output signal including a plurality of pulses, and
b. at least at times: supplying the output signal to a summer, and
c. summing of the output signal by the summer over a time interval.

In accordance with an example embodiment of the present invention, the system according to the present invention includes the features that
a. the detector is designed and configured in such a way that it provides an output signal that comprises a plurality of pulses, and
b. the system comprises a summer to which the output signal is supplied at least at times and that is designed and configured such that it sums the output signal over a time interval.

The use of an MPPC or SiPM detector provides the necessary sensitivity with regard to the light quantity of even the smallest particles (e.g., in the range of 10-30 nm, for example 23 nm or 10 nm diameter), because these cast a power level of only a few pW onto the active detector surface. Such a detector detects individual photons with a detection efficiency of for example a few % up to 50% (depending on the design and depending on the wavelength of the photon). Here, the photon produces a very short current or voltage pulse having a FWHM of for example a few ns to some 100 ns at the output of the detector. Because an internal amplification of the signal takes place in the detector, this can be detected as a single event (possibly after further amplification). At the same time, even without incident light the detector produces signals in individual fashion through thermal excitation (so-called dark counts), with a rate in the kilohertz to megahertz range. The signal of the light of a particle would then appear as an accumulation of pulses in front of a uniform background.

The detection of the very fast and short pulses (which may be only a few nanoseconds) presents a challenge for the electronics here. The electronics also have to be able to process the individual pulses with a frequency of up to 100 MHz to 1 GHz, because this corresponds to the signal of a large particle having a size for example of >100 nm. The present invention provides a possible signal and data processing architecture that permits the rapid and efficient detection of the pulses, but also enables an evaluation of the data with an acceptable outlay and low costs.

Typically, MPPC/SiPM detectors use large SPAD (Single-Photon Avalanche Diodes) in order to achieve a high degree of detection efficiency (small pixels result in large surfaces that are used for the wiring, and, considered relatively, have a smaller effective surface). However, such large pixels have signal FWHMs in the range of for example 50-200 ns, in particular approximately 100 ns. Nonetheless, here, in the detection of large particles signal repetition rates may occur on the order of magnitude of GHz.

The method according to an example embodiment of the present invention permits both a measurement of the number concentration and of the mass concentration of particles or aerosols in a flowing fluid, in particular of soot particles in the exhaust gas of combustion systems and internal combustion engines, for example of diesel and gasoline vehicles. Explicitly included here is the capacity for individual particle detection in a test volume, so that the particle size can also be determined from the measurement data. Here, the method according to an example embodiment of the present invention for the OBD (on-board diagnosis) monitoring of the state of a particle filter can be used. A particle sensor operated with the method according to the present invention has a short response time, and is ready for use almost immediately after activation.

Especially in gasoline vehicles, a particle number measurement capacity, and immediate readiness for use immediately after the start of the vehicle, are very important, because a large portion of the very fine particles (low mass, high number) typically emitted in motor vehicles having a gasoline internal combustion engine occurs during the cold start.

The present invention enables a simplification of the signal evaluation electronics. This improves the cost efficiency and thermal robustness, and makes the particle sensor less susceptible to ESD (electrostatic discharge), i.e., voltage breakdowns, and thus to electrical interference. In addition, the present invention results in a reduction of the computing outlay in an evaluation device of the particle sensor to which data obtained at the output of the summer are supplied, and it permits a more complex evaluation of the data and thus an increase in the information content. In addition, the use of all standard MPPCs/SiPMs is enabled, and the selection of suppliers is thus enlarged. The evaluation of the data read out by the summer in the just-mentioned evaluation device can take place using triggering, data fitting, neural networks, machine learning, and/or AI (artificial intelligence) methods.

In a development of the present invention, it is provided that, at least at times, a time span in which two pulses are outputted in immediately succession is smaller than the overall width of the two pulses, so that a “pile-up” occurs, and that the summer is an integrator that integrates the output signal over a time interval.

Generally, a “pile-up” is a case in which, in a detector, two detection events take place within a time that is shorter than the time duration (in particular the FWHM, where FWHM=Full Width at Half Maximum, or “half value width”) of the individual electrical pulse produced by the detection event. In a pile-up, as a result only one event having a higher pulse height is registered, instead of two events each having a lower pulse height. The above steps b and c (method) are also carried out when, or are carried out precisely when, the output signal has such a pile-up.

The pulses of the individual SPADs thus fuse at the output of the MPPC/SiPM detector to form a “hill.” The total charge of the hill here corresponds to the total charge of the individual pulses, i.e. the information is maintained over the total number of pulses.

Therefore, the charge at the signal output of the detector is preferably used for a determined time (e.g., 0.5-3 μs, for example 1 μs) as measurement signal, and, at least in such a case, the individual pulses are not counted, but rather an integral is formed over this measurement signal. Thus, MPPC/SiPM detectors are also possible not having a fast output (a property of particular SiPMs in which an additional output outputs a particularly short pulse (a few nanoseconds) when there is a photon detection), for use in a LII particle sensor.

In an alternative and relatively easy-to-realize development of the present invention, it is provided that the summer is a counter that sums the number of pulses within a time interval. Such a counter can be realized as an extremely fast-working counter that detects the individual pulses and increments a counter state upward, provided at the output of the counter.

It may be advantageous if the output signal of the detector is amplified by an amplifier before the summation by the summer.

In a development of the present invention, it is provided that duration of the time interval is variable. In this way, the duration of the time interval can be individually adapted to a current operating situation and to an expected quantity of soot particles. In this way, the processing efficiency is increased.

In a development of the present invention, it is provided that the output of the summer is digital and preferably parallel. In this way, the processing of the data provided by the integrator is simplified.

In a development of the present invention, for this purpose it is provided that 1 bit at the output of the summer at most corresponds approximately to the expected integral of the voltage or of the current of an individual pulse, preferably approximately to the expected integral of the voltage or of the current of half an individual pulse. This can be ensured by a corresponding wiring. In this way, an adequate resolution is enabled, which ultimately permits an expanded noise filtering. Preferably, here the summer provides at the output a signal having a value in the range of at most approximately 4-16 bits, preferably in the range of approximately 8-12 bits. This results from the pulse rate of typical detectors for the largest particles to be detected (e.g., approximately 1 GHz) and a typical maximum time interval (e.g., approximately 1 μs), from which, for example, a maximum number of 1000 pulses results, or a required value of 10 bits (=1024).

In a development of the present invention, it is provided that the summer can be reset by an external signal, in particular after the expiration of a specified time interval after a last resetting. In this way, overrunning of the summer, or outputting unnecessarily large values, is prevented.

In a development of the present invention, it is provided that the state of the summer is read out at time intervals, the time intervals being fixed or flexibly controllable. Typically, the summer is read out at time intervals of 0.5-5 μ, in particular at time intervals of approximately 1 μs. This simplifies the evaluation.

In a development of the present invention, it is provided that data read out from the summer are first supplied to a buffer that is permanently read out, in particular being read out after receiving a specified quantity of data. For example, it would be possible for X numbers having Y bits to be read out once per time unit (for example 100 numbers having 10 bits once per 1 μs), and that a fast evaluation/assessment of the overall data packet takes place with a frequency of Z MHz (for example approximately 1 MHz). For this purpose, it is true that comparatively fast and high-power computing elements would be required, but one would then have a type of “real-time processing.”

In an alternative development of the present invention, it is provided that data read out from the summer are first supplied to a buffer, a specified quantity of the last-obtained data is stored in the buffer, and this stored quantity is then outputted as a data packet to an evaluation device. The buffer could for example store the X last values (for example approximately 100) of the summer and then forward these as work packets to the evaluation device. This would have the advantage that the evaluation device receives new data from the buffer with a significantly lower frequency (e.g., approximately 10 kHz) instead of the values of the summer with a much higher frequency (for example approximately 1 MHz). However, correspondingly larger data packets would then have to be processed. This development thus has the advantage that comparatively large data packets do have to be processed in the evaluation device, but only at specified time intervals, so that correspondingly suitable processors can be used.

In a development of the present invention, it is provided that data read out from the summer are supplied to an evaluation device that processes the obtained data in stages, such that in a first stage those data packets are identified that have a specified property, and in a second stage only these identified data packets are evaluated. For example, a rough preselection of the “interesting” data packets (for example containing, with high probability, a particle event) and a subsequent, more elaborate evaluation (i.e., extraction of the relevant information) of these preselected few data packets can take place. In this way, very relevant information, for example about comparatively large soot particles, can be obtained even given comparatively low computing power.

As mentioned above, before the summer there can be situated an amplifier, and after the summer a buffer can be situated, and after the buffer there can be situated an evaluation device. Some or all of these elements can be integrated in a dedicated ASIC. In this way, a high processing speed, small constructive size, and economical price are possible. However, it is also possible for individual components to be realized as discrete components or as micro-ASICs. For example, the amplifier and the summer could be realized as such discrete components or as micro-ASICs. In addition, it is possible for some or all of the above-named components to be realized as software in a microcontroller or microprocessor. Finally, it is also possible for some or all of the above-named components to be housed in an engine control device of an internal combustion engine. Each of the named possibilities has its advantages, namely economical price, small constructive space, easy application possibility, etc.

In a development of the present invention, it is provided that the summer has at least two inputs. Such a summer thus has a double input, so that the signals from the detector can also flow to one input while the other input is evaluated.

Subsequently a changeover takes place, so that the one input can be evaluated while the data flow to the other input. In this way, the processing capacity of the summer is improved.

In the following, specific embodiments of the present invention are explained with reference to the figures.

### BRIEF DESCRIPTION OF THE DRAWINGS

FIG. 1 shows a schematic diagram explaining the design of a particle sensor that operates according to the principle of laser-induced incandescence, in accordance with an example embodiment of the present invention.

FIG. 2 shows a more detailed representation of the design of the particle sensor of FIG. 1, including the representation of a flowing fluid in which the particles are present, in accordance with an example embodiment of the present invention.

FIG. 3 shows a schematic diagram of a system for processing the signal of the detector of the particle sensor, in accordance with an example embodiment of the present invention.

FIG. 4 shows a diagram in which a first type of a digital output signal of the detector of the particle sensor of FIGS. 1 and 2 is plotted over time, in accordance with an example embodiment of the present invention.

FIG. 5 shows a diagram in which a second type of a digital output signal of the detector of the particle sensor of FIGS. 1 and 2 is plotted over time, in accordance with an example embodiment of the present invention.

FIG. 6 shows a flow diagram of a method for processing the digital output signal of the detector of the particle sensor of FIGS. 1 and 2, in accordance with an example embodiment of the present invention.

In the description below, functionally equivalent elements and regions have the same reference characters.

### DETAILED DESCRIPTION OF EXAMPLE EMBODIMENT

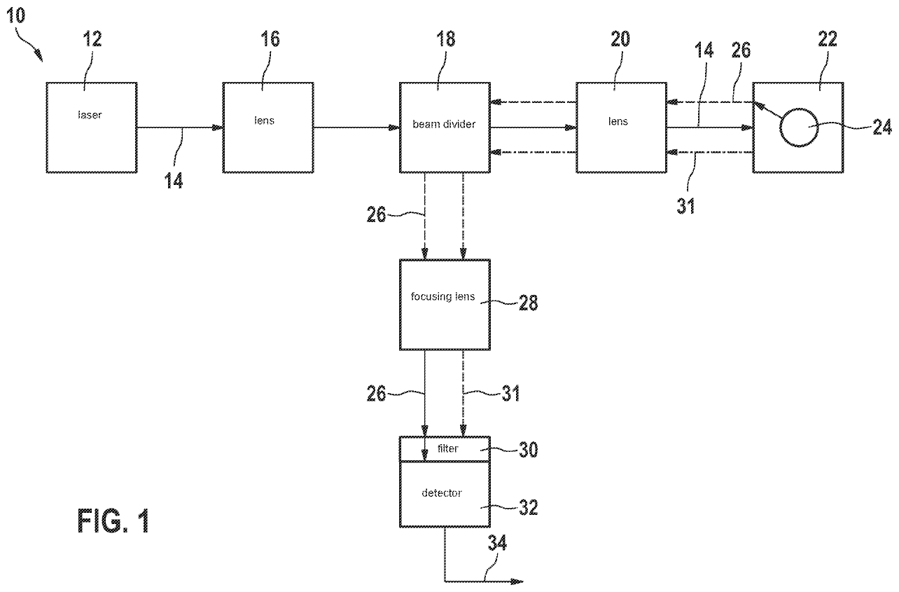

FIG. 1 shows a schematic diagram of a possible specific embodiment of a particle sensor 10. First recognizable is a laser 12, in the present case for example a CW (continuous wave) laser, that emits laser light 14. Laser 12 can in particular have a laser diode, which is very low in cost. Laser light 10 is first shaped to form a parallel beam by a lens 16, which beam then passes through a beam divider 18, for example in the form of a beam splitter or a dichroic mirror. From there it travels to a lens 20, and then continues in focused form to a spot 22. Here, a spot 22 is understood as a volume element having very small dimensions, in the pm range or even in the nm range.

High-intensity laser light 14 can, in spot 22, impinge on a particle 24 present there, for example a soot particle in the exhaust gas stream of an internal combustion engine (not shown). In spot 22, the intensity of laser light 24 is so high that the energy of laser light 14 absorbed by particle 24 heats particle 24 to several thousand degrees Celsius (only in the volume of spot 22 does the intensity of laser light 14 reach the high values necessary for laser-induced incandescence). As a result of the heating, particle 24 emits significant radiation 26 (dashed arrows), spontaneously and essentially without a preferred direction, in the form of temperature radiation, also referred to as LII light. A portion of temperature radiation 26 is therefore also emitted opposite to the direction of incident laser light 14. Temperature radiation 26 is for example in the near infrared and visible spectral range, but is not limited to this spectral range.

Temperature radiation 26 of a particle 24 excited in spot 22 by laser light 14 in turn passes through lens 20 back to beam divider 18, where it is deflected by 90°, passes through a focusing lens 28, and passes through a filter 30 (which is not necessarily present) to a detector 32. Filter 30 is designed such that it filters out the wavelengths of laser light 14, which is also radiated back to a limited extent (dash-dotted arrows 31). Thus, filter 30 reduces the interfering background. The use of a simple edge filter is also possible. This improves the signal-to-noise ratio.

In a specific embodiment (not shown) of the present invention, the laser light from the laser is conducted to the focusing lens by a light waveguide and corresponding optical elements that couple the light in and out. The same also holds for the LII light that is to be detected. However, it is not necessarily required for the laser light and the LII light to be correspondingly focused and collected via the same lens.

The dimensions of spot 22 are in the range of a few μm, in particular in the range of at most 200 μm, so that particles 24 passing through spot 22 are excited to emit evaluable radiation power levels, whether by laser-induced incandescence or by chemical reactions (in particular oxidation). As a consequence, it can be assumed that it is always the case that at most one particle 24 is situated in spot 22, and that a momentary output signal 34 of particle sensor 10 originates only from this at most one particle 24.

Output signal 34 is produced by detector 32, which is situated in particle sensor 10 in such a way that it detects radiation 26, in particular temperature radiation, emanating from particles 24 flying through spot 22. To this extent, output signal 34 provided by detector 32 is a variable characterizing the temperature radiation acquired by detector 32. Detector 32 preferably includes a multi-pixel photon counter (MPPC) or a silicon photon multiplier (SiPAD) or an SPAD diode (single-photon avalanche diode), which acquires temperature radiation 26 and produces digital output signal 34 in the form of pulses having a particular voltage, or having a particular current. The stronger temperature radiation 26 is, the more pulses are outputted per time unit. In this way, an individual particle measurement is possible that enables the extraction of information about particles 24, such as size and speed.

With the named types of detectors 32, even a light signal produced by a particularly small particle 24, and which is therefore extremely small, formed for example by a few photons, can be detected. In this way, the dimensions of particles 24 that are still just detectable is reduced to a lower detection limit of up to 10 nm.

It is certainly possible for laser 12 to be modulated, or switched on and off (duty cycle <100%). However, it remains preferable for laser 12 to be a CW laser. This enables the use of low-cost semiconductor laser elements (laser diodes), which makes the complete particle sensor 10 less expensive, and greatly simplifies the controlling of laser module 12 and the evaluation of output signal 34. However, the use of pulsed lasers is not excluded.

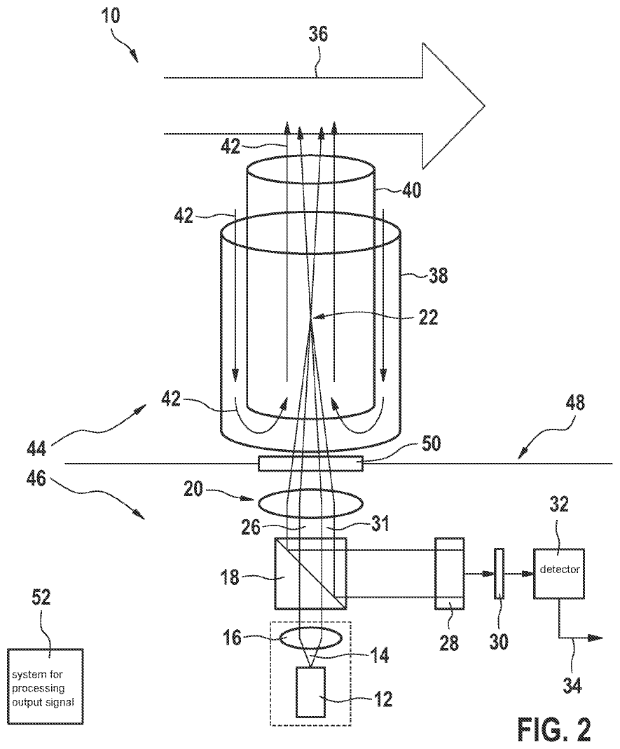

FIG. 2 shows, in more detail, an advantageous exemplary embodiment of a particle sensor 10 suitable for use as a soot particle sensor in an exhaust gas 36 of a combustion process, for example in the exhaust gas system of an internal combustion engine (diesel or gasoline) of a motor vehicle. To this extent, exhaust gas 36 is an example of a fluid flowing with a particular speed that contains particles 24.

Particle sensor 10 has a configuration of an outer protective tube 38 and an inner protective tube 40. The two tubes 38, 40 preferably have a general cylindrical shape or prismatic shape.

The base surfaces of the cylindrical shapes are preferably circular, elliptical, or polygonal. Protective tubes 38, 40 are preferably configured coaxially, the axes of protective tubes 38, 40 being oriented transverse to the flow of exhaust gas 36. Inner protective tube 40 extends, in the direction of the axes, beyond outer protective tube 38 and into the flowing exhaust gas 36. At the end of the two protective tubes 38, 40 oriented away from flowing exhaust gas 36, outer protective tube 38 extends past inner protective tube 40. The inner diameter of outer protective tube 38 is preferably larger than the outer diameter of inner protective tube 40 by an amount large enough that a first, and in the present case approximately circular annular, flow cross-section results between the two protective tubes 38, 40. The inner diameter of inner protective tube 40 forms a second, in the present case preferably circular, flow cross-section.

This geometry has the result that exhaust gas 36 enters via the first flow cross-section into the configuration of the two protective tubes 38, 40, and then, at the end of protective tubes 38, 40 facing away from exhaust gas 36, changes its direction, enters into inner protective tube 40, and is suctioned out therefrom by exhaust gas 36 flowing past (arrows having reference character 42). In inner protective tube 40 this results in a laminar flow. This configuration of protective tubes 38, 40 is fastened on or in an exhaust gas pipe (not shown) transverse to the direction of flow of exhaust gas 36. Spot 22 is situated in the interior of inner protective tube 40. This design has the particularly important advantage that only a single optical access to exhaust gas 36 is required, because the same optical system, in particular the same lens 20, is used both to produce spot 22 and to acquire temperature radiation 26 going out from particle 24.

Particle sensor 10 preferably has a first part 44 (protective tubes 38 and 40) exposed to exhaust gas 36 and a second part 46 not exposed to exhaust gas 36, which contains the optical components of particle sensor 10. The two parts 44, 46 are separated by a separating wall 48 that runs between protective tubes 38, 40 and the optical elements of particle sensor 10. Wall 48 insulates the sensitive optical elements against the hot, chemically aggressive, and “dirty” exhaust gas 36. In separating wall 48, in the beam path of laser light 14 there is situated a protective window 50 through which laser light 14 moves into exhaust gas 36 or stream 42, and via which the temperature radiation 26 going out from spot 22 can impinge on lens 20, and from there, via beam divider 18 and filter 30, can impinge on detector 32.

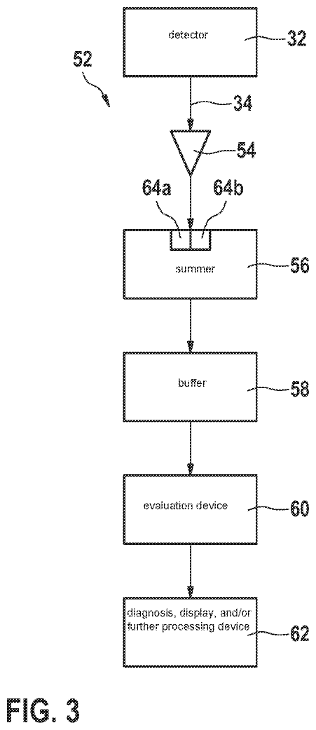

Particle sensor 10 has in addition a system 52 for processing the output signal 34 of detector 32 that is designed and configured to provide, on the basis of output signal 34 of detector 32, an evaluation of the variable provided by detector 32 and characterizing acquired temperature radiation 26. For this purpose, system 52 has components that are shown in more detail in FIG. 3:

First, system 52 has an amplifier 54, which however is optional. After amplifier 52 there is situated a summer 56, and after this there is situated a buffer 58, which however is also optional. An output of buffer 58 is connected to an evaluation device 60, which in turn is connected to a diagnosis, display, and/or further processing device 62. Integrator 57 has, in the present case, for example two inputs 64a and 64b.

Some or all of these elements can be integrated in a dedicated ASIC. However, it is also possible for individual components to be realized as discrete components or as micro-ASICs. For example, amplifier 54 and summer 56 can be realized as such discrete components or as micro-ASICs. In addition, it is possible for some or all of the above-named components to be realized as software in a microcontroller or microprocessor, the software being stored on a corresponding electrical storage medium. Finally, it is also possible for some or all of the above-named components to be housed in an engine control device of an internal combustion engine.

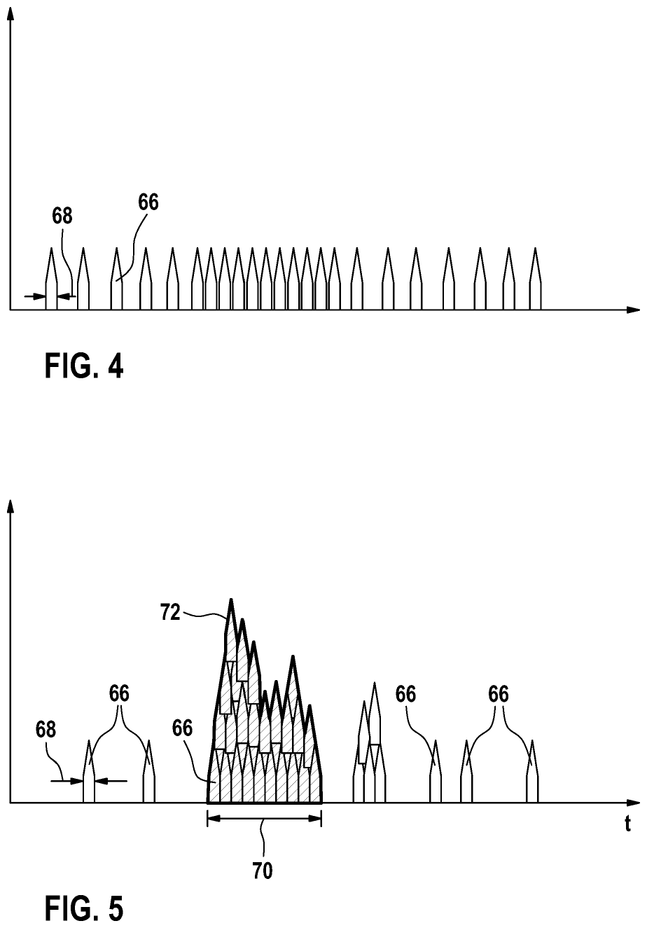

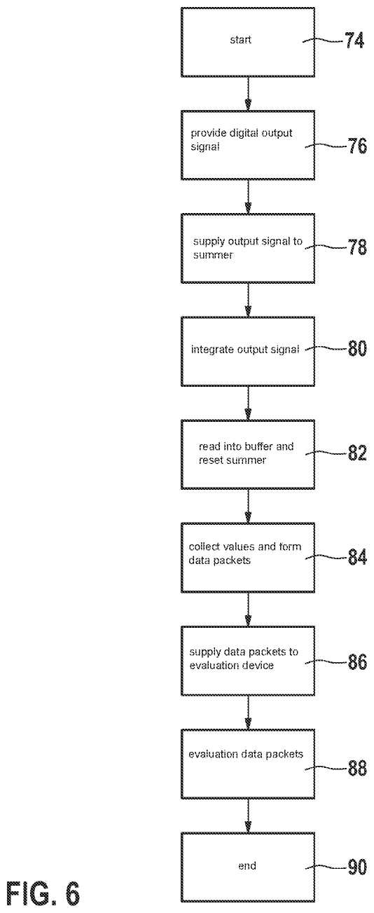

FIG. 4 shows digital output signal 34 of detector 32 in more detail. It will be seen that output signal 34 can include individual pulses (single counts), designated 66. These have a half-value width (FWHM) designated 68. Detector 32 detects individual photons with a very high detection efficiency. Here, the photon produces a very short current or voltage pulse 66 having an FWHM 68, which can be for example in the range of from a few ns to some 100 ns.

As can be seen in FIG. 5, in the detection of large particles 24 having a correspondingly strong temperature radiation 26, signal repetition rates on the order of magnitude of GHz can however occur; thus, within a very short time a multiplicity of individual pulses 66 is produced. This can result in a pile-up.

In the present context, “pile-up” refers to the case in which, in detector 32, a plurality of electrical pulses 66 are produced within a time duration (reference character 70 in FIG. 4) that is shorter than the sum of the time durations (FWHMs 68) of the individual produced electrical pulses 66. Thus, pulses 66 fuse at the output of detector 32 to form a “hill,” outlined in FIG. 4 by a thick black line that is designated 72. The overall charge (=surface) of hill 72 here corresponds to the overall charge of the individual pulses 66. Thus, in the case of a pile-up only one event (namely a single hill 72) having a higher pulse height is registered, instead of a plurality of events each having lower pulse height.

Standardly, a digital output signal 34, corresponding for example to that of FIG. 4, is evaluated by a summer 56 in the form of a counter that acquires the number of pulses 66 per time unit, and in this way infers a detection event, in the present case the presence of a particle 24 in spot 22. Here, the number of pulses 66 per time unit is a function of the strength of temperature radiation 26. The more pulses 66 that are counted per time unit, the stronger temperature radiation 26 is, and the larger particle 24 is.

As explained above, however, it can happen that, given very large particles 24, the indicated pile-up can occur, as is shown in FIG. 5. Therefore, in such a case output signal 34 is used in a manner similar to an analog measurement signal, and in summer 56 the integral is formed over the individual pulses 66 (in the case of individual pulses) and over “hill” 72 (in the case of a pile-up), with variable integration time. Thus, in this specific embodiment summer 56 is realized as an integrator, and at its output it outputs a corresponding value.

Here, the output of summer 56 is preferably likewise digital, and is parallel, but can also be serial. Preferably, the wiring is realized such that 1 bit of summer 56 corresponds approximately to the expected charge of a pulse 66 of detector 32. A higher resolution (e.g., 2 bits per pulse 66) is even more advantageous, and permits an expanded noise filtering. Moreover, summer 56 can be reset by an external signal. Summer 56 preferably provides at its output a signal having a value in the range of at most approximately 4-16 bits, preferably in the range of approximately 8-12 bits. This results from the pulse rate of typical detectors 32 in the case of the largest particles 24 to be detected (corresponding to a signal repetition rate of, e.g., approximately 1 GHz), and a typical maximum time interval (e.g., approximately 1 μs), from which there results for example a maximum number of 1000 pulses, or a required value of 10 bits (=1024). Because summer 56 has a double input, having two inputs 64a and 64b, output signals 34 can flow from detector 32 to the one input 64a, while the other input 64b is evaluated (i.e., integrated). Subsequently a changeover takes place, so that the one input 64a can be evaluated while the data of output signal 34 flow to the other input 64b.

The state of summer 56 is read out at regular or flexibly controllable time intervals, for example once per 1 μs. The data obtained at the output of summer 56 can in principle be supplied directly to evaluation device 60. In the present case, and as an example only, these data are however supplied to buffer 58, which stores a specified number, for example 100, of the last values of summer 56, and then forwards them as a working packet to evaluation device 60.

In the present case, evaluation device 60 processes the data obtained from summer 56 for example in a plurality of stages, for example in two stages. In a first stage, those data packets are identified that have a specified property, and in a second stage only these identified data packets are evaluated. For example, a rough preselection can be made of the “interesting” data packets, where a data packet is to be classified for example as “interesting” if, based on the size of the integral, it indicates with high probability the detection of a particle, possibly even a particularly large particle 24. A more elaborate evaluation, in which for example the shape of hill 72 is ascertained and from this the shape of particle 24 is inferred, then takes place only for such a selected “interesting” data packet. The evaluation of the data read out from summer 56 in evaluation device 60 can take place using triggering, data fitting, neural networks, machine learning, and/or AI (artificial intelligence) methods.

However, it would also be possible in principle for buffer 58, which moreover in principle can also be integrated in evaluation device 60, to be permanently read out, for example for a specified number of values to be read out once per time unit. In particular, 100 10-bit numbers can be read out once per μs. Such permanently read-out data could then be processed using a very fast evaluation with high frequency, for example 1 MHz.

A method for processing signal 34 of particle sensor 10 is now explained with reference to FIG. 5. The method begins in a start block 74. In a block 76, digital output signal 34 is provided by detector 32. In a block 78, output signal 34 is supplied to summer 56. If summer 56 is realized as an integrator, then in a block 80 output signal 34 is integrated over a time interval. If, in contrast, summer 56 is fashioned as a counter, the number of pulses within the time interval is counted. In a block 82, the value obtained corresponding to the integral, or to the counter state at the output of summer 56, is read into buffer 58, and summer 56 is reset. In a block 84, the values moved into buffer 58 are collected to form data packets, and in a block 86 the collected data packets are supplied to evaluation device 60. In a block 88, the data packets are evaluated in evaluation device 60. The method ends in a block 90.

1-14. (canceled)

15. A method for processing the output signal of a particle sensor that operates according to laser-induced incandescence, comprising the step:
providing an output signal from a detector that characterizes a temperature radiation acquired by the detector, the output signal including a plurality of pulses;
at least at times: supplying the output signal to a summer; and
summing the output signal by the summer over a time interval.

16. The method as recited in claim 15, wherein at least at times, a time period in which two pulses are outputted in immediate succession is smaller than a total width of the two pulses, so that a “pile-up” occurs, and the summer is an integrator that integrates the output signal over the time interval.

17. The method as recited in claim 15, wherein the summer is a counter that sums a number of the pulses within the time interval.

18. The method as recited in claim 15, wherein a duration of the time interval is variable.

19. The method as recited in claim 15, wherein an output of the summer is digital.

20. The method as recited in claim 19, wherein the output of the summer is parallel.

21. The method as recited in claim 20, wherein 1 bit at the output of the summer at most corresponds approximately to an expected integral of a voltage, or of a current, of an individual pulse.

22. The method as recited in claim 21, wherein the bit corresponds approximately to the expected integral of the voltage, or of the current, of half an individual pulse.

23. The method as recited in claim 15, wherein the summer can be reset by an external signal after an expiration of a specified time interval after a last resetting.

24. The method as recited in claim 15, wherein a state of the summer is read out at time intervals, the time intervals being fixed or flexibly controllable.

25. The method as recited in claim 15, wherein data read out from the summer are at first supplied to a buffer that is permanently read out after receiving a specified quantity of data.

26. The method as recited in claim 15, wherein data read out from the summer are first supplied to a buffer, a specified number of last-received data is stored in the buffer, and the stored number is then outputted as a data packet to an evaluation device.

27. The method as recited in claim 15, wherein data read out from the summer are provided to an evaluation device that processes the received data in stages, such that in a first stage those data packets are identified that have a specified property, and in a second stage only the identified data packets are evaluated.

28. A system for processing an output signal of a particle sensor that operates according to laser-induced incandescence, comprising:
a detector that provides an output signal that characterizes an acquired temperature radiation, the output signal including a plurality of pulses; and
a summer to which the output signal is supplied at least at times and that is configured such that the summer sums the output signal over a time interval.

29. The system as recited in claim 28, wherein the summer has at least two inputs.

30. A particle sensor that operates according to laser-induced incandescence, the particle sensor comprising:
a system for processing an output signal of a particle sensor that operates according to laser-induced incandescence, the system including:
a detector that provides an output signal that characterizes an acquired temperature radiation, the output signal including a plurality of pulses; and
a summer to which the output signal is supplied at least at times and that is configured such that the summer sums the output signal over a time interval.
